(19) United States
(12) Patent Application Publication
(10) Pub. No.: US 2007/0125650 A1
(43) Pub. Date: Jun. 7, 2007

(54) Treatment of Biological Samples Using Dielectrophoresis

(75) Inventors: Mario Scurati, Milano (IT); Torsten Mueller, Berlin (DE); Thomas Schnelle, Berlin (DE)

Correspondence Address: TAMSEN VALOIR, PH.D.;BAKER & MCKENZIE LLP, PENNZOIL PLACE, SOUTH TOWER, 711 LOUISIANA, SUITE 3400, HOUSTON, TX, 77002-2746, US

(73) Assignees: STMicroeletronics S.r.l., Agrate Brianza (IT); Evotec Technologies GmbH, Dusseldorf (DE)

(21) Appl. No.: 11/531,679

(22) Filed: Sep. 13, 2006

(30) Foreign Application Priority Data
Sep. 14, 2005 (EP) EP05108445.7

(51) Int. Cl. B03C 5/02

(52) U.S. Cl. 204/547; 204/643

(57) ABSTRACT

A plurality of planar electrodes (5) in a microchannel (4) is used for separation, lysis and PCR in a chip (10). Cells from a sample are brought to the electrodes (5). Depending on sample properties, phase pattern, frequency and voltage of the electrodes and flow velocity are chosen to trap target cells (16) using DEP, whereas the majority of unwanted cells (17) flushes through. After separation the target cell (16) are lysed while still trapped. Lysis is carried out by applying RF pulses and/or thermally so as to change the dielectric properties of the trapped cells. After lysis, the target cells (16) are amplified within the microchannel (4), so as to obtain separation, lysis and PCR on same chip (1).

### CROSS-REFERENCE TO RELATED APPLICATIONS

This application claims priority to EP 05108445.7, filed Sep. 14, 2005, and is incorporated in its entirety herein by reference.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

The present invention relates to a method and device for the treatment of biological samples using dielectrophoresis.

As is known, dielectrophoresis (DEP) is increasingly used in microchips to manipulate, identify, characterize and purify biological and artificial particles. DEP exploits frequency dependent differences in polarizability between the particles to be treated and the surrounding liquid that occur when RF (Radio Frequency) electric fields are applied thereto via microelectrodes.

In case of biological particles, to which reference is made without losing generality, the microelectrodes can additionally be used to apply DC (Direct Current) voltage pulses of high amplitude (of the order of 100 V) for short times (of the order of microseconds) to destroy membrane integrity of dielectrophoretically captured cells, for later PCR-Polymerase Chain Reaction (see, e.g., U.S. Pat. No. 6,280,590). On the other hand, solid-phase PCR (on-chip PCR) has been developed for later detection of products, e.g. in microarray format already commercially available [see, e.g., http://www.vbc-genomics.com/on_chip_pcr.html and WO-A-93/22058).

The theoretical background of DEP will be described herein below.

If a time-periodic electric field is applied to a dielectric particle, the particle is subject to a dielectrophoretic force that is a function of the dielectric polarizability of the particle in the liquid, that is the difference between the tendencies of particle and of the liquid to respond to the applied electrical field. In particular, for a spherical dielectric particle of radius R subject to an electric time-periodic field E having a root-mean-square value \vec{E}ᵣₘₛ and angular frequency ω, the particle is subject to a dielectrophoretic force whose time averaged value [symbol] \vec{F}_{d} [symbol] _{αν} can be expressed using the dipole approximation as:

$${〈 {\vec{F}}_{d} 〉}_{av} = 2 {πɛ}_{1} {R}^{3} Re [ {f}_{CM} ] * ∇ {\vec{E}}_{rms}^{2} \qquad ( 1 )$$

wherein εₗ is the liquid permittivity and f_{CM} represents the above dielectric polarizability tendency, called the Clausius-Mossotti factor (see M. P. Hughes, Nanoelectromechanics in Engineering and Biology. 2002: CRC Press, Boca Raton, Fla. 322 pp). For a homogeneous sphere suspended in a liquid, the Clausius-Mossotti factor has been found to be:

$${f}_{CM} = \frac{{\tilde{σ}}_{p} - {\tilde{σ}}_{l}}{{\tilde{σ}}_{p} + 2 {\tilde{σ}}_{l}} with \tilde{σ} = σ + ⅈωɛ \qquad ( 2 )$$

wherein σ represents the conductivity (the index p referring to the particle and the index l referring to the liquid) and ε is the absolute permittivity.

For a more complex particle, the effective particle conductivity σ has to be used; e.g., in case of a particle with spherical shape, formed by a shell (membrane) enclosing a different material in the interior, it reads:

$${\tilde{σ}}_{p} = {\tilde{σ}}_{m} \{ \frac{{a}^{3} + 2 ( \frac{{\tilde{σ}}_{i} - {\tilde{σ}}_{m}}{{\tilde{σ}}_{i} + 2 {\tilde{σ}}_{m}} )}{{a}^{3} - 2 ( \frac{{\tilde{σ}}_{i} - {\tilde{σ}}_{m}}{{\tilde{σ}}_{i} + 2 {\tilde{σ}}_{m}} )} \} \qquad ( 3 )$$

wherein the indices i and m refer to particle interior and membrane, respectively, and a=R/R h for a membrane with thickness h. R is again the particle radius.

FIG. 1 illustrates the relative dielectrophoretic force for lymphocytes (continuous line) and erythrocytes (broken lines) for media having three different conductivities. The dielectric spectra (ƒ_{CM}*R²) shifts to higher frequencies as conductivities rise and particles switch between positive DEP (pDEP, where the particles are attracted towards the electrodes), and negative DEP (nDEP, where the particles are repelled from the electrodes).

It has been already demonstrated (see Schnelle et al., “Paired microelectrode system: dielectrophoretic particle sorting and force calibration”, J. Electrostatics, 47/3, 121-132, 1999) that cells can be separated if they present different dielectrophoretic behaviour e.g. through different composition and/or size and/or shape, using equilibrium of flow (scaling with particle radius R) and DEP forces between face to face mounted electrode strips.

If a particle showing nDEP at preset conditions is brought by streaming near an energised electrode pair, it is lifted to the central plane, experiencing repulsion forces from both electrodes. FIG. 2 shows both equipotential and current lines between the electrode pair from the analytic solution for a semi-infinite plate capacitor.

Application of electric fields to conductive solutions is accompanied by heating. The balance equation for the temperature T reads:

$$ρ {c}_{p} ( \vec{v} \cdot ∇ T + \frac{\partial }{\partial t} ) = λΔ T + σ {E}_{rms}^{2} \qquad ( 4 )$$

wherein ρ is the liquid density, cₚ is the specific heat, λ is the thermal conductivity and ν is the velocity of the liquid. For example, for water, cₚ=4.18 kJ/(kg K), λ˜0.6 W/(m K). If ρcₚνα<<1, the flow term in eq. 4 can be neglected (v<<4 mm/s in a channel with a height a=40 μm) and eq. 4 can be simplified to:

$$ρ {c}_{p} \frac{\partial }{\partial t} T = λΔ T + σ {E}_{rms}^{2} \qquad ( 5 )$$

The time constant t_{d} for thermal equilibrium can be derived to be:
t_{d}=ρcₚα²/λ (6)
which gives, for an aqueous solution and a=40 μm, t_{d}≅1 ms.

The stationary version of eq. 5 reads:
0=λΔT+σE² (7)

According to a dimensional analysis, this gives an order of magnitude estimate for the temperature rise of:
∂T=σUᵣₘₛ²/λ (8)
wherein Uᵣₘₛ is the root mean square voltage applied between the electrodes. For an aqueous solutions with σ=1 S/m and a root mean square voltage Uᵣₘₛ=5 V, eq. (8) results in T≅42° C. Thus physiological solutions can be heated up to boiling using moderate voltages. The absolute value of temperature depends on the electric field distribution and geometry, and can be usually obtained using numerical procedures. Quantitatively temperature rise is given by:
∂T=γσUᵣₘₛ²/λ (8a)
which wherein γ is a parameter depending on geometry of the system including the phase pattern of the voltage applied to electrodes.

In fact, eqs. (8) and (8a) underestimate the scaling at higher voltages. This is due to the fact the ohmic conductivity σ rises stronger then thermal conductivity λ:
σ(∂T)=σ₀(1+α∂T) α˜0.022/K
λ(∂T)=λ₀(1+β∂T) β˜0.002/K (9)

Taking eq. (9) into account, eq. (8a) results in:
∂T(U)=γσ₀/λ₀U²(1+Γσ₀/λ₀(α−β)U²+O(U⁴)) (10)

Although eq. 10 is only strictly true for homogenous systems, it gives a good estimate for sandwich systems as well.

Based on the above, the object of the invention is to provide a highly efficient and low cost device and method for the manipulation of particles that allow reduction of overall diagnostic time and risk of contamination.

### BRIEF SUMMARY OF THE INVENTION

The term “particle” used in the context of the invention is used in a general sense; it is not limited to individual biological cells. Instead, this term also includes generally synthetic or biological particles. Particular advantages result if the particles include biological materials, i.e. for example biological cells, cell groups, cell components or biologically relevant macromolecules, if applicable in combination with other biological particles or synthetic carrier particles. Synthetic particles can include solid particles, liquid particles or multiphase particles which are delimited from the suspension medium, which particles constitute a separate phase in relation to the suspension medium, i.e. the carrier liquid.

In particular, the invention is advantageously applicable for biological particles, especially for integrated cell separation, lysis and amplification from blood or other cell suspensions.

According to the present invention, there are provided a method and a device for the treatment of biological samples, as defined in claims 1 and 28, respectively.

### BRIEF SUMMARY OF THE DRAWINGS

For the understanding of the present invention, a preferred embodiment is now described, purely as a non-limiting example, with reference to the enclosed drawings, wherein:

FIG. 1 illustrates the relative dielectrophoretic force for lymphocytes and erythrocytes, at three different medium conductivities.

FIG. 2 shows a cross-section of an electrode pair of a capacitor and the existing electrical field.

FIG. 3 shows a cross-section of a device for performing treatment of biological samples, according to a first embodiment of the present invention.

FIG. 4 shows a top plan view of the device of FIG. 3.

FIG. 5 shows a top plan view of a second embodiment of the present device.

FIG. 6 shows a cross-section of a different device, according to a third embodiment of the present invention.

FIG. 7 shows a top plan view of the device of FIG. 6.

FIG. 8 shows a top plan view of a fourth embodiment of the present device.

FIGS. 9-11 are top views of alternative layouts of details of the devices of FIGS. 3-8.

FIGS. 12 and 13 are a top view and a cross-section of a detail of FIG. 11, during a separation step.

FIG. 14a is a top view of a further embodiment of the present device.

FIGS. 14b and 14c are cross sections of the device of FIG. 14a, at two subsequent times.

FIG. 15 shows a three-dimensional simulation of the electric field applied to the device of FIG. 3 in a first working condition.

FIG. 16 shows the result of the separation and lysis treatment in the device of FIG. 15.

FIG. 17 shows a three-dimensional simulation of the electric field applied to the device of FIG. 3 in a second working condition.

FIG. 18 is a plot of electrical quantities for the device of FIG. 17.

FIGS. 19a and 19b are top views of the device of FIG. 17, showing the behavior of particles during separation and lysis, at two subsequent times.

FIG. 20 shows a cross-section of a different embodiment of the present invention.

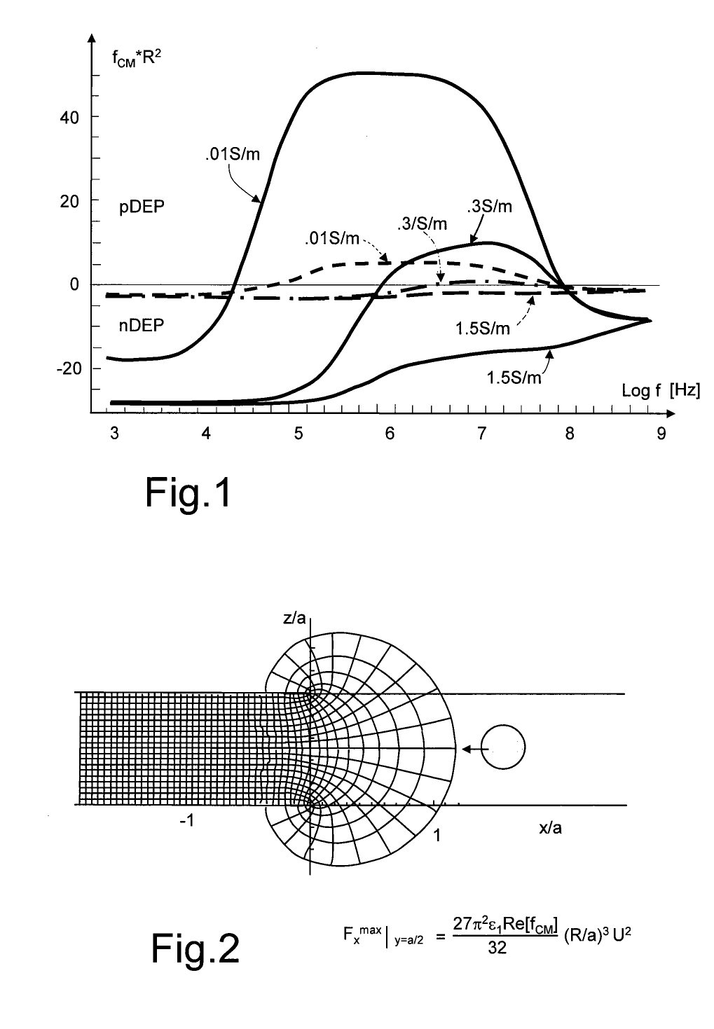

### DETAILED DESCRIPTION OF THE INVENTION

According to one embodiment of the invention, a plurality of planar electrodes in a microchannel are used for separation, lysis and amplification in a chip. Cells from a sample are brought to a first group or array of electrodes. Depending on sample properties, phase pattern, frequency and voltage of the first array of electrodes and flow velocity are chosen to repel/trap target cells (for example, white blood cells or bacteria) using nDEP in regions of low electric field in the fluid between the first group of electrodes and their counterelectrodes, whereas majority of unwanted cells flush through. In the alternative, pDEP is used to trap the target cells near the electrodes. Separation of red blood cells and white blood cells is comparatively easy because the larger white blood cells experience larger relative DEP forces (DEP force versus hydrodynamic force).

During or after separation, target cells are trapped at the same or a second group of electrodes. This can be achieved by switching the frequency of the first group of electrodes to a frequency of pDEP (e.g. from kHz range to lower MHz range for modeled lymphocytes) or switching off the first group of electrodes whilst the second group of electrodes is energized for pDEP. Dielectric properties of the trapped cells can be changed by RF and/or thermal or chemical lysis. The changed cells can be further manipulated (separation/trapping) by nDEP or pDEP at a second group of electrodes.

In a further alternative embodiment, the unwanted cells are first trapped or deflected by pDEP or nDEP using a first electrode array biased at a frequency while the target cells are flushed through. The target cells are then trapped and treated as described above using the same frequency or another frequency on a second electrode array.

To minimize clogging, the electrodes of an array or group can be driven according to predefined (depending on flow velocity) or feedback-controlled time regime such that the groups of electrodes are filled with target cells sequentially. This can be achieved by first switching on the electrodes that are the furthest from the device input (most downstream electrodes). Then, when these electrodes are filled, the electrodes that are immediately upstream are energized, and so on. Here, passivated electrodes with small openings in the passivating layer can be used.

The trapped particles are then lysed to release the information carriers contained therein. The term “information carrier” employed in the context of the invention is used in a general sense, it is not limited to RNA and DNA, it also includes proteins or modified oligonucleotides.

Electric field mediated cell lysis is based on induction of an additional transmembrane potential (TMP) which oscillates with the external field. Its absolute value is approximately given by:

$$TMP ( ω , θ ) = 1.5 E R cos ( θ ) \vert \frac{1}{1 + ⅈωτ} \vert \qquad ( 11 )$$

with a time constant τ mainly depending on membrane capacity τ˜εₘ/d. It drops sharply with frequency (ω=2πf) and is superimposed to the permanent transmembrane potential (pTMP) of about 100 mV resulting from cell charging. When the transmembrane potential exceeds values of about 1 V, membrane breakdown occurs. This results in an increase of membrane conductivity and subsequently change of cell interior. As a consequence, cells originally showing nDEP behaviour are attracted to the electrodes of the same or second group of electrodes. Additionally, the cells can be further lysed either by RF fields or thermally (higher field values near electrodes) or using additional DC high voltage pulses.

Particles can be considered as dielectric bodies consisting of different layers with different electrical properties (Fuhr, G., Müller, T., Hagedorn, R., 1989. Reversible and irreversible rotating field-induced membrane modifications. Biochim. Biophys. Acta 980: 1-8). Thus it is possible to lyse first the nuclear membrane with higher frequencies, and then the outer cell membrane.

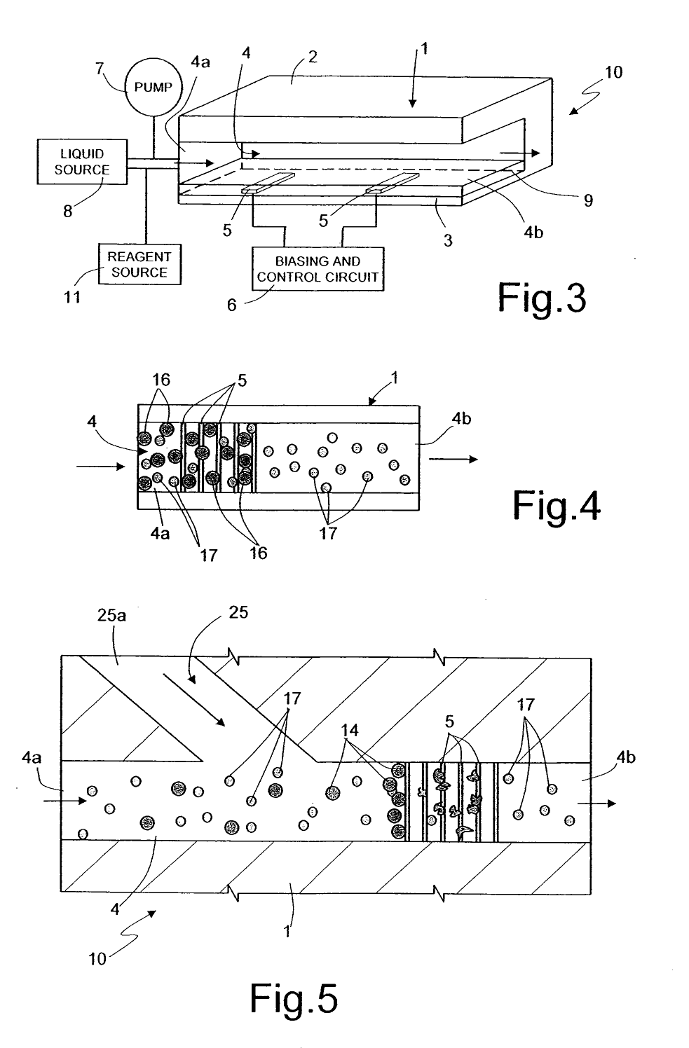

In general, particles can be considered as homogeneous spheres, single- or multi-shell models. For example, a cell with cell nucleus can be considered as 3-shell model, wherein the first layer is the outer membrane, the second layer is cytoplasm, the third layer is the nuclear membrane, and the three layers surround the nuclear body. The electrical loading of the outer membrane decreases with increasing field frequency. In contrast to the behaviour of the outer membrane, the electrical loading of the inner membrane is low at lower frequencies, increases with rising frequencies and decreases again at high frequencies (see Fuhr, G., Müller, T., Hagedorn, R., 1989. Reversible and irreversible rotating field-induced membrane modifications. Biochim. Biophys. Acta 980: 1-8, Fig. 3). The dielectric properties (permittivity, conductivity and thickness) of each layer determines the value of the induced transmembrane potentials. Increasing the conductivity of the outer membrane increases the height of the induced transmembrane potential of the inner membrane.

After lysis, the information carriers are separated from the unwanted lysis products e.g. by flow and dielectrophoresis. In particular, the information carriers are transported to an amplification (PCR) region and/or amplification (PCR) reagents are brought to the electrodes holding the information carriers so as to amplify them. Thermocycling is done using buried elements or using the same trapping electrodes, applying appropriate voltages to realize the required temperature sequences. Beside simplicity, the latter solution has the advantage of faster ramps (down to ms) due to very small heated volumes.

In a further embodiment, the products of amplification can be analysed at a further electrode array e.g. by electric analysis of binding processes of analytes onto specially prepared electrodes. Suitable preparation of electrodes (e.g. coating of gold electrodes by stable organic compounds and further immobilization of biomolecules e.g. DNA or RNA probes) is state of the art and compatible with CMOS technology, see e.g. Hoffman et al., http://www.imec.be/essderc/ESSDERC2002/PDFs/D24_{—}3.pdf).

The binding process can be detected by impedance measurements that have been shown to be sensitive enough to detect molecular events (Karolis et al., Biochimica et Biophysica Acta, 1368, 247-255, 1998). In this way separation, lysis, amplification and detection can be carried out in a simple chip having only fluidic and electric connections, thus reducing cost and time for analysis.

Alternatively, direct analyte detection can be carried out using voltmetric or amperiometric methods (see e.g. Hoffmann et al. or Bard & Fan, Acc. Chem. Res. 1996, 29, 572-578) not requiring surface coating of electrodes. In this case, the same electrodes as used for trapping and or lysis can be used.

Experiments revealed that RF lysed cells remain stably trapped at the electrodes after switching off the field. DC pulses can afterwards be used for additional lysis but also to remove the lysis products if PCR is carried out further downstream. Compared to DC pulses, RF fields have the advantage of minimizing (avoiding) electrochemical reactions at the electrodes (e.g. electrolysis). Further, they better penetrate the cell interior. This is of importance since not only the cell membrane but also the membrane of the nucleus has to be disintegrated. PCR with RF lysed cells was successful without additional DC pulses allowing simplification of electronics and shielding.

FIGS. 3 and 4 show an implementation of a device 10 intended to treat biological samples including mixture of target particles and other particles. In particular, the device 10 of FIGS. 3 and 4 is suitable for separating and amplifying white blood cells, but may also be used for selecting and treating red blood cells (e.g. for detecting special diseases, e.g. malaria, or for carrying out prenatal diagnostic purposes) or for detecting migrating tumor cells or bacteria.

The device 10 of FIGS. 3 and 4 is formed in a chip, e.g. of silicon or glass, comprising a body 1 having a first wall 2 and a second wall 3 enclosing a main channel 4 filled by a liquid injected from an inlet 4a of the channel and including both target cells and unwanted cells (waste). The channel 4 has also an outlet 4b for discharging the unwanted cells as well as the target cells, at the end of the treatment.

Electrodes 5 are formed on the second wall 3 and are connected to a biasing and control circuit 6, shown only schematically, for applying electric pulses to the electrodes 5 and possibly for detection purposes. The electrodes are biased by applying a single or double-phase RF voltage. If the chip comprising the body 1 is of silicon, the biasing and control circuit 6 may be integrated in the same chip. The electrodes 5 are planar electrodes formed by straight metal elements, that are arranged here parallel to each other and perpendicular to the channel 4, and are generally covered by a passivation layer 9. In the alternative, the electrodes 5 may be formed by blank electrode strips.

The body 1 is connected to a pump 7, here shown upstream of the channel 4, for injecting the liquid to be treated from a liquid source 8 into the inlet 4a of the channel 4. Furthermore, a reagent source 11 is also connected to the inlet 4a of the channel 4 for injections of reagents during PCR. In the alternative, the pump 7 could be connected to the outlet 4b to suck the liquid and the reagents out of the respective sources 8, 11, after passing through the channel 4 and being treated therein. In this case, a valve structure may be needed between the reagent source 11 and inlet 4a to control injection.

In any case, the liquid that flows through the channel 4 is subject to a hydrodynamic force, represented here by arrows, drawing the liquid from the inlet 4a towards the outlet 4b. The pump 7 may be integrated in a single chip as body 1, e.g. as taught in EP-A-1 403 383.

With reference to FIGS. 3 and 4, a liquid (e.g., 1-10 μl) comprising a mixture of target cells (16 in FIG. 4) and undesired cells (17 in FIG. 4) is injected into the channel 4 from the liquid source 8 through the inlet 4a. The electrodes 5 are biased so that each electrode is in counterphase with respect to the adjacent electrodes. For example, the electrodes are biased by applying an AC voltage with an amplitude of 1-10 V and a frequency of between 300 KHz and 10 MHz. pDEP or nDEP may be used. If pDEP is used, the target cells 16 are attracted to the electrodes 5, while the unwanted cells 17 are washed out through the outlet 4b. If nDEP is used, the target cells 16 are repelled from the electrodes 5 toward the first wall 2.

Then, the target cells 16 are lysed, either electrically (through application of a DC field or an RF field), chemically or biochemically (through introduction of a lysis reagent), and/or thermally. DC lysis may performed by applying pulses having amplitude of 20-200 V, width of 5-100 μs, and a repetition frequency of 0.1-10 Hz for 1-60 s. AC lysis may performed by applying an AC voltage having amplitude of 3-20V and a frequency of between 10 kHz and 100 MHz. Chemical or biochemical lysis may be performed using known protocols. Thermal lysis may be performed at 45-70° C. Lysis can also be monitored using a fluorescent marker e.g. calcein.

Then, with the lysed target cells 16 trapped against the same trapping electrodes 5 or subsequent suitably biased electrodes 5 arranged downstream of the trapping electrodes, PCR is brought about by introducing a reagent liquid (including polymerase) and carrying out a thermal cycle (thermocyclying) so as to amplify the released information carriers (DNA, RNA or proteins).

The electrodes 5 can be used also for detection, using voltmetric or amperiometric methods. In this case, the biasing and control circuit 6 also comprises the components necessary for generating the needed test currents/voltages and the measuring components and software.

FIG. 5 shows the top view of another embodiment of the device 10 wherein a reagent channel 25 having an inlet 25a is formed directly in the body 1, to allow injection of the reagents for chemical lysis and/or PCR. Otherwise, the device 10 of FIG. 5 is the same as of FIGS. 3 and 4.

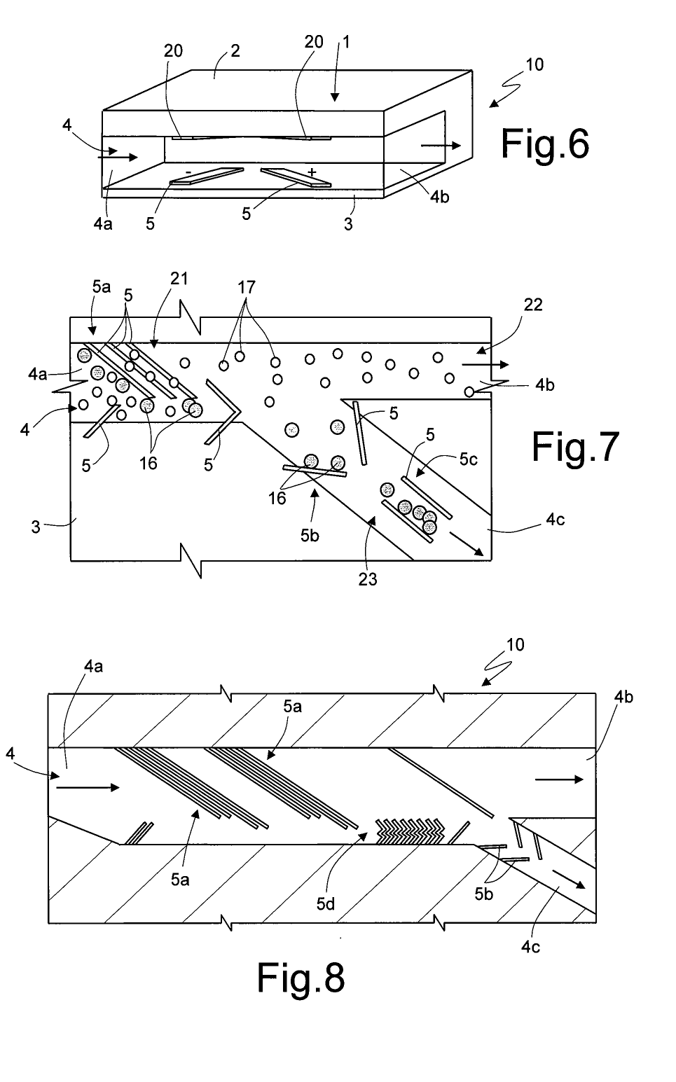

FIGS. 6 and 7 refer to a different embodiment of the device 10, wherein the channel 4 has a deflection portion 21 connected to the inlet 4a and two branch portions, including a waste branch portion 22 and a lysis/amplification portion 23. Waste branch portion 22 extends between the deflection portion 21 and a first outlet 4b, and lysis/amplification portion 23 extends between the deflection portion 21 and a second outlet 4c.

The electrodes 5 are formed on the second wall 3 of the body 1, while a group of counterelectrodes 20 is formed on the first wall 2, opposite the electrodes 5. Each counterelectrode 20 faces a respective electrode 5. The electrodes 5 can be individually biased by the control circuit 6, while the counterelectrodes 20 are generally interconnected and left floating or grounded.

In the embodiment shown in FIGS. 6 and 7, the electrodes 5 and counterelectrodes 20 are arranged along the deflection portion 21 and the lysis/amplification portion 23, transversely thereto. Since the layout of the counterelectrodes 20 is the same as for the electrodes 5, reference will be made hereinafter only to the electrodes 5.

For example, here the electrodes 5 include three groups of electrodes 5a, 5b and 5c. First electrodes 5a are arranged in two sets, parallel to each other and transversely to the channel 4, to form V shapes (hook-like structures), so as to increase the trapping capability. Second electrodes 5b are arranged in the shape of a V along the beginning of the lysis/amplification portion 23. Third electrodes 5c are arranged in the lysis/amplification portion 23, downstream of the second electrodes 5b, and are parallel to each other and to the lysis/amplification portion 23.

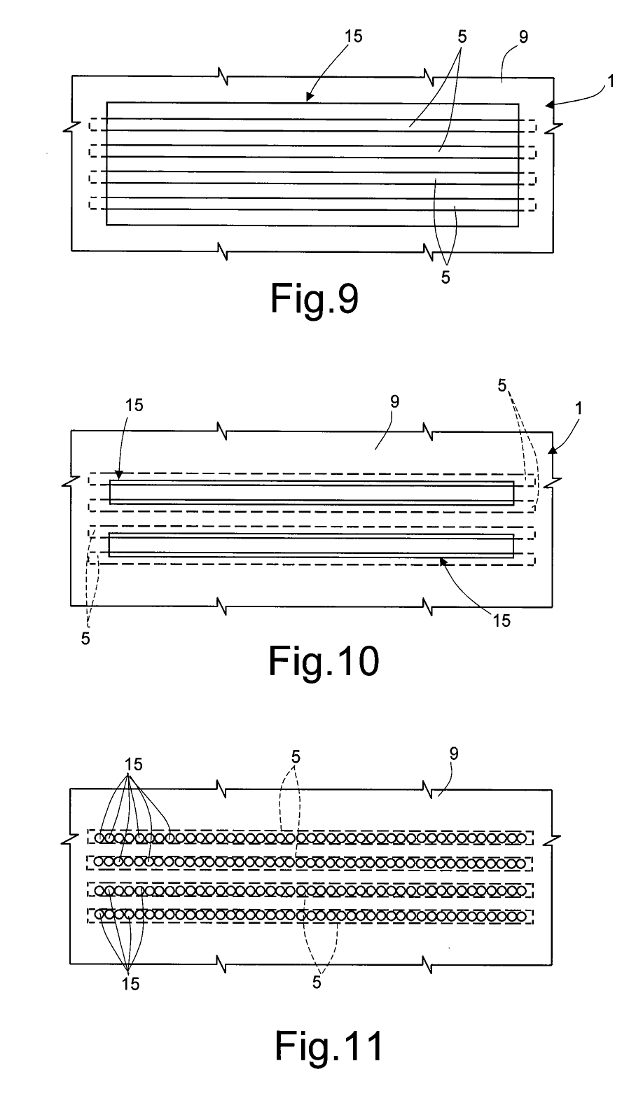

The electrodes 5 and the counterelectrodes 20 are generally covered by a passivation layer, not shown here for sake of clarity and better described with reference to FIGS. 9-11.

Also here, the liquid including the mixture of target and the unwanted cells is injected into the channel 4 through the inlet 4a. The target cells 16 are separated from the unwanted cells 16 in the deflection portion 21 and collected, e.g., between the counterelectrodes 20 and the V-shaped first and second electrodes 5a, 5b, by nDEP, while the unwanted cells 17 are washed out toward the first outlet 4b through the waste branch portion 22. The target cells 16 are then released toward the lysis/amplification portion 23, where they are lysed and amplified.

FIG. 8 shows a device 10 similar to device 10 of FIG. 7, but including fourth electrodes 5d having a zigzag shape in the deflection portion 21, downstream of the first electrodes 5a.

FIG. 9 is a top view of a portion of the channel 4, showing a first layout of the electrodes 5. Here, the electrodes 5 are formed by blank straight metal strips and the passivation layer 9 has an opening 15 just over the electrodes 5. Here, during trapping by pDEP, the target cells 16 are attracted to the regions of high field, at the electrode edges.

In the embodiment of FIG. 10, the passivation layer 9 has a plurality of openings 15 stretching between and partly on top of two contiguous electrodes 5, so that the passivation 9 does not cover the two facing halves of pairs of electrodes 5. In this case, during trapping by pDEP, the target cells 16 are attracted to the electrode edges that are not covered by the passivation (at the openings 15).

In the embodiment of FIG. 11, the openings 15 in the passivation layer 9 have circular shape and extend along each electrode 5, near two facing edges of pairs of electrodes 5.

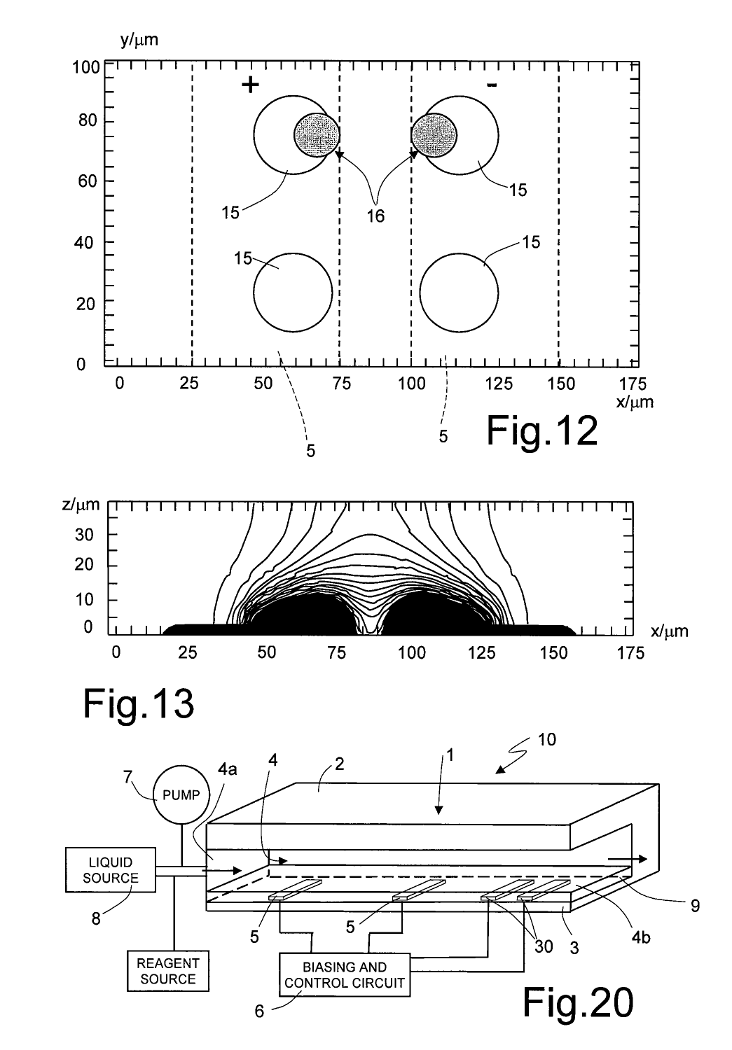

Here, as shown in the enlarged detail of FIG. 12, during trapping by pDEP, the target cells 16 are attracted at the small openings 15, where the field is maximum, as visible from FIG. 13, showing the plot of the mean square electric field distribution.

The use of circular openings 15 in the passivation layer 9 is advantageous because it allows reduced overall sample loss and heating. Furthermore, the openings 15 of small dimensions reduce the risk of clogging, because only few particles are trapped at each hole.

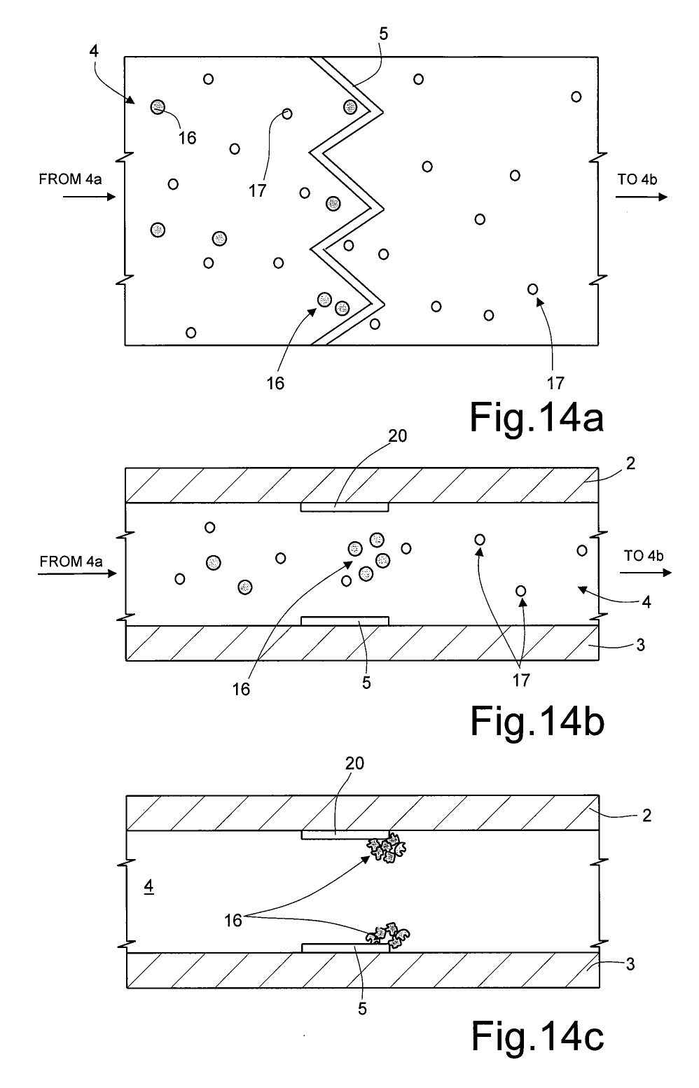

FIGS. 14a-14c shows another embodiment, wherein the device 10 includes electrodes 5 arranged on first wall 3 and counterelectrodes 20 arranged on second wall 2 of the device 10. The electrodes 5 and the counterelectrodes 20 are zigzag-shaped and are arranged facing each other. As shown in the top view of FIG. 14a and in the cross-section of FIG. 14b, first the target cells 16 (here, white blood cells) are retarded and trapped by nDEP in the space between electrodes 5 and counterelectrodes 20, while the unwanted cells 17 (here, red blood cells 17) flow through, towards the outlet 4b. Then in FIG. 14c, the target cells 16 are lysed and change their behavior to pDEP. Thus, they are attracted by both the electrodes 5 and the counterelectrodes 20, where they can be further lysed and subjected to PCR.

FIG. 20 shows an embodiment similar to the one of FIG. 3, wherein an array of detection electrodes 30 is formed in a different portion of the device 10. The electrodes 30 cooperate with biasing and control circuit 6 to perform an electric analysis of binding processes of analytes onto specially prepared electrodes. To this end, the detection electrodes 30 are suitably prepared, e.g. gold electrodes are coated with stable organic compounds, wherein biomolecules, e.g. DNA or RNA probes, have been immobilized, as known in the art. The binding process can be detected by impedance measurements performed through the biasing and control circuit 6. In this way separation, lysis, amplification and detection can be carried out in a simple chip having only fluidic and electric connections, thus reducing cost and time for analysis.

The devices 10 of FIGS. 3-20 may be advantageously used to separate and detect white blood cells, as discussed in the examples given below.

### EXAMPLE 1

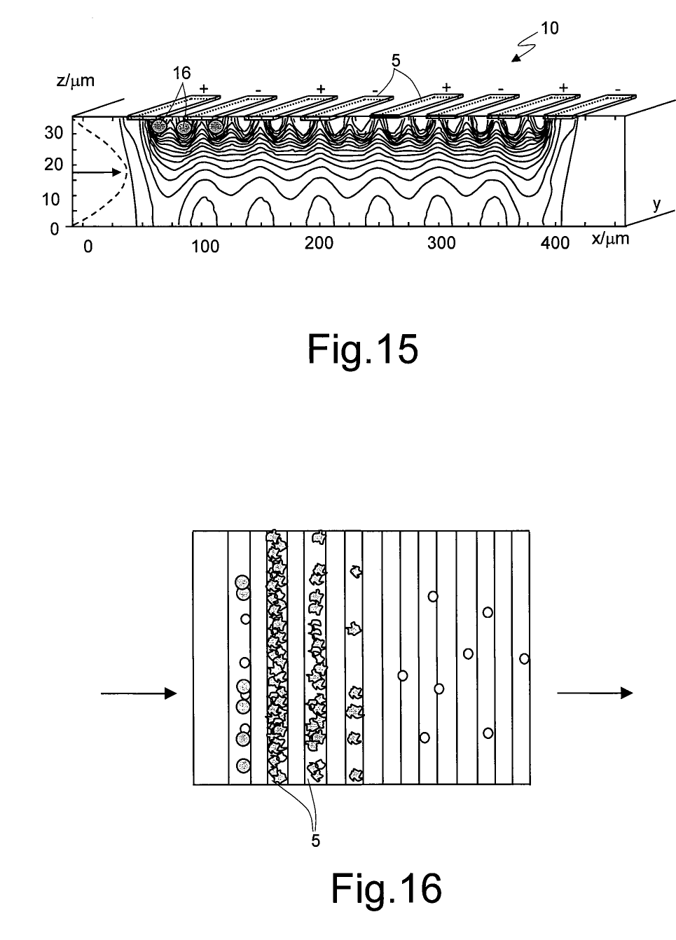

The device 10 of FIGS. 3 and 4 was used for separating white blood cells using pDEP conditions. To this end, a diluted blood liquid (1:200, with a conductivity adjusted to 0.12 S/m) was injected in the inlet 4a at a flow rate of 6 nl/s. The electrodes were biased at an AC voltage having an amplitude of 8.5 V and a frequency of 5 MHz. Each electrode 5 was biased in counterphase with respect to the adjacent electrodes. White blood cells 16 were trapped at the electrodes 5, while red blood cells 17 passed to the outlet 4b almost unaffected, as visible from FIG. 15 showing a simulation of the electric field in a test device 10. In FIG. 15, the device was drawn upside down with gravity g acting from below.

Then the trapped blood cells were electrically lysed by applying DC pulses (with amplitude 131 V, duration 20 μs and repetition frequency of 0.5 Hz). FIG. 16 shows the trapping of lysed white blood cells 16.

Next PCR reagents were introduced in the device 10 and temperature cycles were applied. In particular, the PCR reagents are shown in Table 1, and the temperature cycles included a pre-denaturation cycle at 94° C. for 3 m; twelve cycles including denaturation at 94° C. for 40 s, annealing at 58° C. for 42 s, and extension at 72° C. for 45 s; then twenty-three cycles including denaturation at 94° C. for 40 s, annealing at 46° C. for 40 s, and extension at 72° C. for 45 s.

TABLE 1
Preparation of PCR master mix to be added to 1 μl sample

| | Master Mix |
|---|---|
| Pure water | 10 μl |
| Sigma 2× Mix* | 15 μl |
| Primer 1** | 1.5 μl |
| Primer 2 | 1.5 μl |
| Total Volume | 28 μl |

*Sigma Extract-N-Amp ™ Blood PCR Kit (Sigma ™ cat. No XNAB2R Lot 91K9295)
**Primers (MLH-1, 3′ and 5′ primer, Evotec Technologies ™)

The results are not shown, but successful cell separation, lysis and amplification was achieved.

### EXAMPLE 2

The device 10 of FIGS. 3 and 4 was used for separating white blood cells using nDEP conditions for white blood cells. To this end, a diluted blood liquid having the same composition as in the first test was injected in a device 10, wherein the electrodes were biased at A=8.5 V, f=320 MHz.

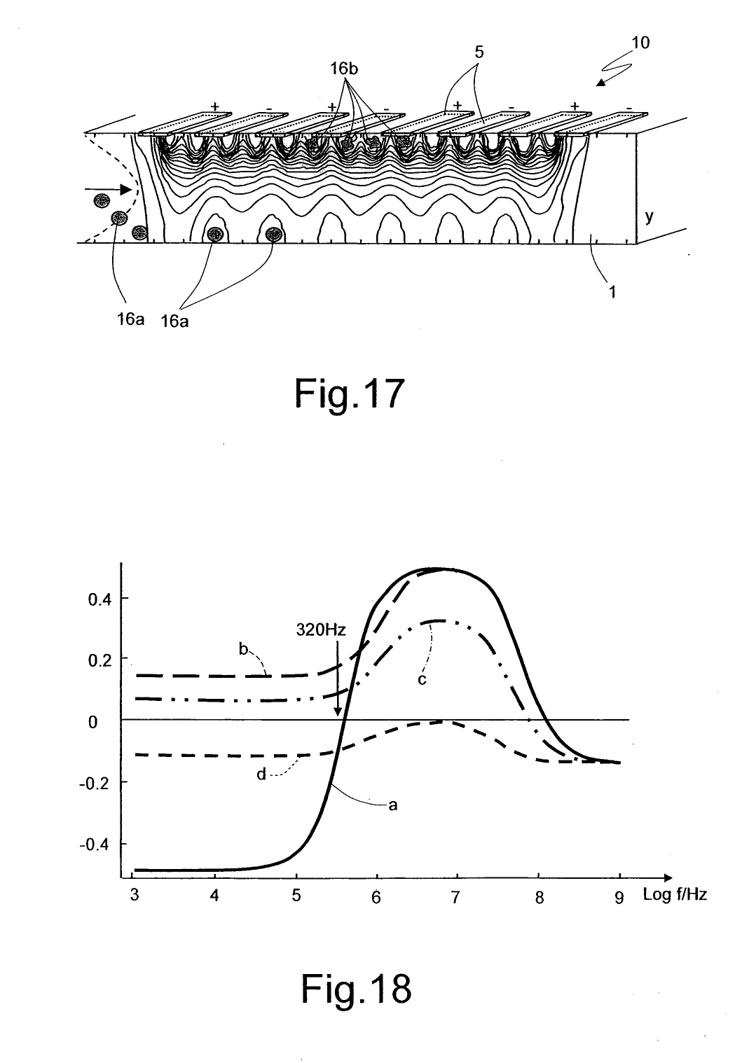

White blood cells 16 were trapped at the first wall 2 opposite to electrodes 5, while red blood cells 17 passed to the outlet 4b almost unaffected, as visible from FIG. 17, showing an upside down device 10, wherein white cells 16a are shown trapped in minimum field position.

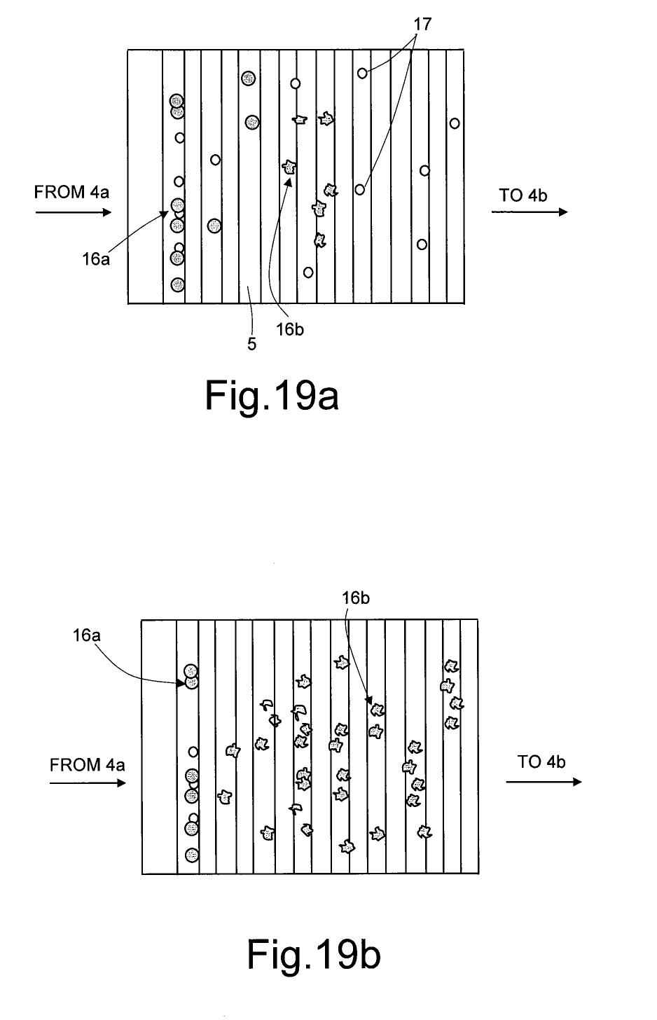

Then, the trapped white blood cells were electrically lysed by applying an RF voltage to a second group of electrodes 5 (A=11 V, f=320 kHz). In particular, during this phase, a change of dielectrophoretic behaviour of the white blood cells was observed. In fact lysis was accompanied by an increase of membrane conductivity resulting in a change from nDEP (curve a in FIG. 18, showing the plot of the dielectrophoretic force as a function of the frequency of white blood cells) to pDEP behaviour (curve b) at moderate external conductivity (about 0.1 S/m). Then ion leakage decreasing internal conductivity was observed (curves c and d in FIG. 18). Trapping and lysis of white blood cells 16 is also visible from FIG. 19a, 19b, which illustrate the device viewed through a transparent upper wall 2 at two subsequent times and showing first nDEP (cells 16a) and then pDEP trapping (cells 16b).

Thereafter, the lysed cells were subject to amplification as discussed in example 1. Results are not shown, but successful amplification was achieved.

The advantages of the present invention are clear from the above. In particular, implementation of a single microdevice for particle separation, lysis and amplification allows reduction of the overall diagnostic time and risk of contamination. Furthermore, samples of smaller volumes can be used, thus further reducing the diagnostic costs, and the risk of sample loss due to fluid transfer needs is eliminated.

Finally, it is clear that numerous variations and modifications may be made to the device and process described and illustrated herein, all falling within the scope of the invention as defined in the attached claims.

What is claimed is:

1. A method for the treatment of biological samples in a device comprising the steps of:
generating an AC field within said device;
introducing a liquid in the device, the liquid including first and second particles having different dielectrophoretic (DEP) behavior while subject to same conditions;
separating the first particles from the second particles, based on said different DEP behaviour;
trapping the first particles through said AC field within said device;
lysing the first particles, as trapped in the device to release information carriers contained in said first particles; and
amplifying the information carriers in the device.

2. The method of claim 1, wherein the step of amplifying the information carriers comprises performing a polymerase chain reaction (PCR) treatment.

3. The method of claim 2, wherein said device has a first wall, a second wall, and at least one first electrode formed on said second wall, said first and second walls facing each other, wherein said trapping comprises biasing said first electrode.

4. The method of claim 3, wherein said biasing comprises applying a voltage causing attraction of said first particles against said first electrode.

5. The method of claim 4, wherein said lysing is carried out while said first particles are trapped at or in the vicinity of said first electrode.

6. The method of claim 4, wherein said lysing comprises biasing at least one second electrode spaced apart from said at least one first electrode to cause said first particles to be attracted to and to be trapped at said second electrode, thereby said first particles being lysed while trapped at said second electrode.

7. The method of claim 3, wherein said step of trapping comprises biasing said first electrode to cause said first particles to be repelled from said first electrode, said lysing being carried out while said first particles are trapped away from said first electrode.

8. The method of claim 7, wherein said lysing comprises biasing said first electrode to cause lysed first particles to be attracted to said first electrode.

9. The method of claim 8, wherein said first wall has at least one counterelectrode arranged facing said first electrode, wherein said step of trapping further comprises biasing said counterelectrode to cause said first particles to be repelled also from said counterelectrode and to be trapped in a space between said first electrode and said counterelectrode, said lysing being carried out while said first particles are trapped in said space, causing lysed first particles to be attracted to said electrode and to said counterelectrode.

10. The method of claim 7, wherein said lysing comprises biasing a second electrode spaced apart from said first electrode to cause said lysed first particles to be attracted to and to be trapped at said second electrode after lysis.

11. The method of claim 10, further comprising a plurality of groups of electrodes arranged alongside said first electrode along said device, said trapping comprising subsequently biasing said first electrode and said groups of electrodes.

12. The method of claim 11, comprising biasing first a most-downstream located group of electrodes, then biasing in sequence more-upstream located groups of electrodes.

13. The method of claim 12, wherein said lysing is carried out by biasing said first electrode.

14. The method of claim 13, wherein said lysing comprises applying an RF voltage to said first electrode so as to cause a change of the DEP behavior of the trapped first particles.

15. The method of claim 13, wherein said lysing comprises applying a DC pulsed voltage to said first electrode so as to cause a change of the DEP behavior of the trapped first particles.

16. The method of claim 12, wherein said lysing is carried out thermally.

17. The method of claim 12, wherein said lysing is carried out chemically.

18. The method of claim 17, wherein said amplifying comprises thermocycling using said first electrode.

19. The method of claim 10, wherein said amplifying comprises heating said second electrode and performing a thermal cycle.

20. The method of claim 1, wherein said step of separating comprises trapping said second particles in a first zone of the device by means of said AC field while the first particles flush through said first zone; and said step of trapping the first particles comprises trapping the first particles in a second zone of the device, after being separated from the second particles.

21. The method of claim 1, wherein said step of separating comprises deflecting said second particles toward a first zone of the device by means of said AC field while the first particles flush toward a second zone; and said step of trapping the first particles comprises trapping the first particles in the second zone of the device, after being separated from the second particles.

22. The method of claim 21, wherein during said step of separating, said AC field in said first zone has a first frequency and a first amplitude and during said step of trapping the first particles said AC field in said second zone has said first frequency and a second amplitude, different from said first amplitude.

23. The method of claim 21, wherein during said step of separating, said AC field in said first zone has a first frequency and a first amplitude and during said step of trapping the first particles said AC field in said second zone has a second frequency and a first amplitude, different from said first frequency.

24. The method of claim 21, wherein during said step of separating, said AC field in said first zone has a first frequency and a first amplitude and during said step of trapping the first particles said AC field in said second zone has a second frequency and a second amplitude, different from said first amplitude and said first frequency.

25. The method of claim 21, wherein during said step of separating, said AC field in said first zone has a first frequency and during said step of trapping the first particles said AC field in said second zone has a second frequency, different from said first frequency.

26. A method for the treatment of biological samples in a device having a first and a second wall, the second wall being opposite the first wall, the method including the steps of:
generating an AC field between said first and second walls;
introducing a liquid between said first and second walls, the liquid including first and second particles having different dielectrophoretic (DEP) behavior while subject to same conditions;
trapping the first particles away from said second wall, while the second particles flow away;
lysing the first particles while trapped;
causing a change of the DEP behavior of the trapped first particles; and
trapping the lysed first particles on the second wall.

27. The method of claim 26, wherein the step of causing a change of the DEP behavior of the trapped first particles includes causing said first particles to change from nDEP to pDEP.

28. A device for the treatment of biological samples, comprising a body having:
a channel having a first and second wall;
means for introducing a liquid in the channel;
at least one electrode on said second wall;
means for AC biasing said electrode thereby causing separation target particles in said liquid using dielectrophoresis;
means for trapping said target particles in said liquid within said channel;
means for lysing the target particles as trapped in said channel and releasing information carriers contained in said target particles; and
means for amplifying the information carriers in the channel.

29. The device of claim 28, wherein first wall has at least one counterelectrode arranged facing said electrode.

30. The device of claim 28, wherein said electrode is a blank electrode.

31. The device of claim 28, comprising a passivation covering said electrode and holes in said passivation.

32. The device of claim 31, wherein said electrode is an elongated element and said holes comprise apertures extending along a main edge of said elongated element.

33. The device of claim 31, wherein said electrode is an elongated element and said holes comprise a plurality of circular apertures aligned along a main edge of said elongated element.

34. The device of claim 33, wherein said channel comprises a first and a second inlet.

35. The device of claim 34, wherein said channel comprises a first and a second outlet.

36. The device of claim 35, wherein said body comprises means for detecting the amplified information carriers.

37. The device of claim 36, wherein said means for detecting are impedance detecting means.

38. The device of claim 37, wherein said means for detecting comprises said electrode.

39. The device of claim 37, wherein said means for detecting comprises an own array of detection electrodes.
